(19) United States
(12) Patent Application Publication
(10) Pub. No.: US 2007/0068483 A1
(43) Pub. Date: Mar. 29, 2007

(54) Overrun fuel cutoff in controlled autoignition of a gasoline engine

(76) Inventor: Andre-Francisco Casal Kulzer, Boeblingen (DE)

Correspondence Address: KENYON & KENYON LLP, ONE BROADWAY, NEW YORK, NY, 10004, US

(21) Appl. No.: 11/522,008

(22) Filed: Sep. 14, 2006

(30) Foreign Application Priority Data
Sep. 14, 2005 (DE) 102005043685.4

(51) Int. Cl. F02B 17/00; F02D 17/02; F02B 5/00; F02D 7/00

(52) U.S. Cl. 123/295; 123/481; 123/198 F; 123/305

(57) ABSTRACT

In a method for operating an internal combustion engine, particularly a gasoline engine with direct gasoline injection, having a plurality of cylinders, fuel consumption and emissions are further minimized by operating one part of the cylinders in an overrun fuel cutoff operating mode and another part of the cylinders in an autoignition operating mode.

### FIELD OF THE INVENTION

The present invention relates to a method for operating an internal combustion engine, particularly a gasoline engine with direct gasoline injection, having a plurality of cylinders, as well as a control unit for carrying out the method.

### BACKGROUND INFORMATION

Direct gasoline injection and variable valve gears in the gasoline engine represent the state of the art. They also give the possibility of describing homogeneous, engine-related combustion processes. First of all, homogeneous and stratified gasoline-engine combustion processes with externally supplied ignition, having direct injection and variable valve gears are known; secondly, new homogeneous, autoigniting combustion processes are being tested because of their high mileage and emissions (reduction) potential. The open-loop/closed-loop control of the autoignition, as well as the program-map area in which this combustion process is usable play a decisive role in connection with new autoigniting combustion processes.

In direct-injection gasoline engines known from the related art, gasoline is injected directly into the combustion chamber of a cylinder of the internal combustion engine. The gasoline/air mixture compressed in the combustion chamber is subsequently ignited by firing a spark in the combustion chamber. The volume of ignited gasoline/air mixture expands explosively and sets in motion a piston that is movable back and forth in the cylinder. The back-and-forth movement of the piston is transferred to a crankshaft of the internal combustion engine.

Direct-injection internal combustion engines can be operated in various operating modes. As a first operating mode, a so-called stratified-charge operating mode is known, which is used especially in the case of smaller loads. As a second operating mode, a so-called homogeneous operating mode is known, which is used in the case of greater loads on the internal combustion engine. The various operating modes differ particularly in the point of injection and the injection period, as well as in the moment of ignition.

In stratified-charge operating mode, the gasoline is injected into the combustion chamber during the compression phase of the internal combustion engine in such a way that, at the moment of ignition, there is a fuel cloud in the immediate vicinity of a spark plug. This injection can be accomplished in different ways. Thus, it is possible that the injected fuel cloud is already near the spark plug during or immediately after the injection, and is ignited by it. It is likewise possible that the injected fuel cloud is carried toward the spark plug by a charge movement, and is only then ignited. In both combustion processes, there is no uniform fuel distribution in the combustion chamber, but rather a stratified charge.

The advantage of the stratified-charge operating mode is that the smaller loads present are able to be realized by the internal combustion engine using a very small quantity of fuel. Greater loads, however, cannot be satisfied by the stratified-charge operating mode.

In the homogeneous operating mode used for larger loads, the gasoline is injected during the intake phase of the internal combustion engine, so that a turbulence and therefore a distribution of the fuel in the combustion chamber can still easily take place even prior to the ignition. To that extent, the homogeneous operating mode corresponds approximately to the operating mode of internal combustion engines in which, in conventional manner, fuel is injected into the intake manifold. If necessary, the homogeneous operating mode may also be used for smaller loads.

During operation of an internal combustion engine in the HCCI (homogeneous charge compression ignition) mode, which is sometimes also known as CAI (controlled auto ignition), ATAC (active thermo atmosphere combustion) or TS (Toyota Soken), the air/fuel mixture is not ignited by externally supplied ignition, but rather by controlled autoignition. The HCCI combustion process can be caused, for example, by a high portion of hot residual gases and/or by a high compression and/or a high intake-air temperature. A prerequisite for the autoignition is a sufficiently high energy level in the cylinder. Internal combustion engines operable in the HCCI mode are described, for example, in U.S. Pat. No. 6,260,520, U.S. Pat. No. 6,390,054, German Patent No. DE 199 27 479 and PCT International Patent Publication No. WO 98/10179.

Compared to a conventional combustion with externally supplied ignition, the HCCI combustion has the advantage of reduced fuel consumption and lower emissions. However, the regulation of the combustion process, and especially the control of the autoignition of the mixture is complex. Thus, it requires regulating of the manipulated variables influencing the combustion process, such as for the fuel injection (injected fuel quantity, point of injection and injection duration), internal or external exhaust-gas recirculation, intake and exhaust valves (variable valve timing), exhaust-gas back pressure (exhaust-gas flap), possibly an ignition assist, air-intake temperature, fuel quality and compression ratio in internal combustion engines having variable compression ratio.

Moreover, a cylinder shutoff at lower loads offers an additional potential for savings on fuel consumption. These days, cylinder shutoff in homogeneous and stratified combustion processes for gasoline engines with externally supplied ignition is no longer a very great challenge. However, it has not yet been realized in the case of homogeneous autoignition.

New homogeneous combustion processes for gasoline engines are only usable in a limited program-map area, and only given a very well defined thermodynamic state of the cylinder charge, particularly at high temperatures due to high exhaust-gas recirculation or exhaust-gas retention. An object of the present invention is to further minimize fuel consumption and emissions.

### SUMMARY OF THE INVENTION

This objective is achieved by a method for operating an internal combustion engine, particularly a gasoline engine with direct gasoline injection, having a plurality of cylinders, one part of the cylinders being operated in an overrun fuel cutoff operating mode and another part of the cylinders being operated in an autoignition operating mode.

The method permits the control of the autoignition at low load points with additional potential to reduce fuel consumption by a selective cylinder shutoff strategy with the aid of variable valve timing and direct gasoline injection. The cylinder shutoff can be used especially at lower loads. The program-map area in which autoignition is able to be realized is limited downwards because of too low a charge temperature, with the result that the autoignition may be interrupted. By the cylinder shutoff, a higher load would be set at the cylinders that are still intended to fire and do work, so that one could thereby drive even smaller loads than in autoignition operating mode without cylinder shutoff. In addition, by cylinder shutoff, a lower fuel consumption can be achieved, particularly in the case of smaller loads.

In one further refinement of the method, a transition takes place from the overrun fuel cutoff operating mode to the autoignition operating mode via an operating mode with externally supplied ignition. To be able to operate cylinders of an internal combustion engine in the cylinder shutoff operating mode, a change is necessary between ignited operation and non-ignited operation. The thermodynamic conditions, especially the temperature, during the overrun fuel cutoff, hinder a direct transition to autoignited operation. Therefore, an operation with externally supplied ignition is selected as transition. In the transition from the overrun fuel cutoff operating mode to the autoignition operating mode, preferably a plurality of power strokes take place in the operating mode with externally supplied ignition. For example, there can be approximately one to ten, preferably approximately five to ten power strokes in the operating mode with externally supplied ignition.

A transition from the autoignition operating mode to the overrun fuel cutoff operating mode preferably takes place directly, thus without a transition through power strokes with externally supplied ignition.

The operating mode with externally supplied ignition is preferably an operating mode with homogeneous mixture formation, since here relatively high gas temperatures are reached, and thus the gas temperatures necessary for autoignition may easily be achieved by inner or outer exhaust-gas recirculation.

The problem indicated at the outset is also solved by a control unit for an internal combustion engine, particularly a gasoline engine with direct gasoline injection, having a plurality of cylinders; it includes means for operating one part of the cylinders in an overrun fuel cutoff operating mode and another part of the cylinders in an autoignition operating mode.

### BRIEF DESCRIPTION OF THE DRAWINGS

FIG. 1 shows a schematic representation of a cylinder of an internal combustion engine having a fuel supply system.

FIG. 2 shows a diagram of the combustion-chamber pressure over the crankshaft angle.

FIG. 3 shows a flow chart of the method.

### DETAILED DESCRIPTION

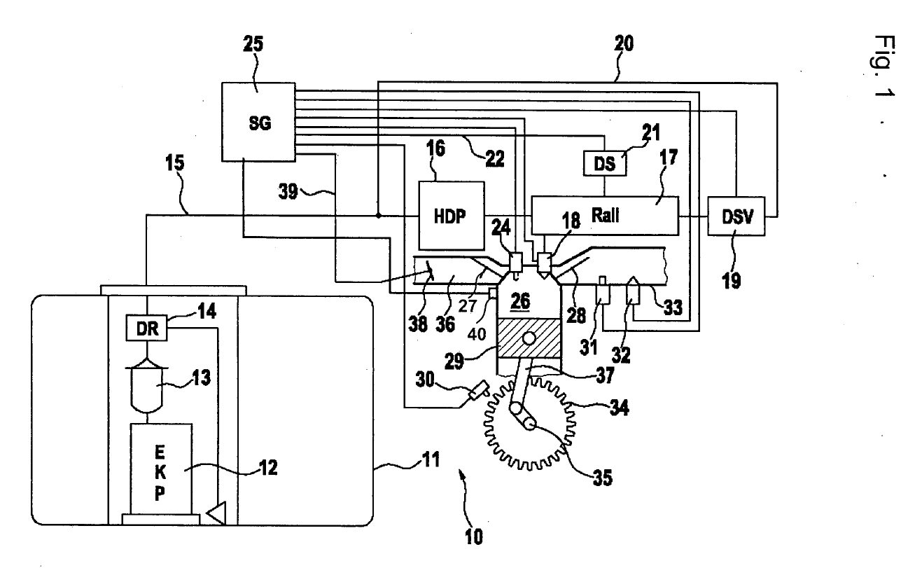

FIG. 1 shows a schematic representation of a cylinder of an internal combustion engine with associated components of the fuel supply system. Shown by way of example is an internal combustion engine with direct injection (gasoline engine with direct gasoline injection DGI) having a fuel tank 11, on which an electric fuel pump (EFP) 12, a fuel filter 13 and a low-pressure regulator 14 are disposed. A fuel line 15 runs from fuel tank 11 to a high-pressure pump 16. An accumulator chamber 17 is adjacent to high-pressure pump 16. Situated at accumulator chamber 17 are fuel injectors 18 which preferably are assigned directly to combustion chambers 26 of the internal combustion engine. In internal combustion engines having direct injection, at least one fuel injector 18 is assigned to each combustion chamber 26; however, a plurality of fuel injectors 18 may be provided for each combustion chamber 26 here, as well. The fuel is delivered by electric fuel pump 12 from fuel tank 11 via fuel filter 13 and fuel line 15 to high-pressure pump 16. Fuel filter 13 has the function of removing foreign particles from the fuel. With the aid of low-pressure regulator 14, the fuel pressure in a low-pressure area of the fuel supply system is regulated to a predetermined value that is usually on the order of magnitude of approximately 4 to 5 bar. High-pressure pump 16, which preferably is driven directly by the internal combustion engine, compresses the fuel and delivers it to accumulator chamber 17. In so doing, the fuel pressure reaches values of up to approximately 150 bar. FIG. 1 shows, by way of example, one combustion chamber 26 of an internal combustion engine with direct injection; in general, the internal combustion engine has a plurality of cylinders having one combustion chamber 26 each. At least one fuel injector 18, at least one spark plug 24, at least one intake valve 27, and at least one exhaust valve 28 are situated at combustion chamber 26. The combustion chamber is bounded by a piston 29, which is able to slide up and down in the cylinder. Fresh air is drawn in from an induction tract 36 via intake valve 27 into combustion chamber 26. With the aid of fuel injector 18, the fuel is injected directly into combustion chamber 26 of the internal combustion engine. The fuel is ignited by spark plug 24. The expansion of the ignited fuel drives piston 29. The movement of piston 29 is transferred via a connecting rod 37 to a crankshaft 35. Disposed on crankshaft 35 is a segment disk 34 that is scanned by a speed sensor 30. Speed sensor 30 generates a signal which characterizes the rotational movement of crankshaft 35.

The exhaust gases formed during the combustion travel out of combustion chamber 26 via exhaust valve 28 to an exhaust pipe 33, in which a temperature sensor 31 and a lambda probe 32 are situated. Temperature sensor 31 measures the temperature and lambda probe 32 measures the oxygen content in the exhaust gases.

A pressure sensor 21 and a pressure-control valve 19 are connected to accumulator chamber 17. Pressure-control valve 19 is connected on the incoming side to accumulator chamber 17. On the output side, a return line 20 leads to fuel line 15.

Instead of a pressure-control valve 19, a fuel supply control valve may also be used in fuel supply system 10. Pressure sensor 21 acquires the actual value of the fuel pressure in accumulator chamber 17 and supplies it to a control unit 25. On the basis of the acquired actual value of the fuel pressure, control unit 25 generates a driving signal which drives the pressure-control valve. Fuel injectors 18 are driven via electrical output stages (not shown), which may be disposed inside or outside of control unit 25. The various actuators and sensors are connected to control unit 25 via control-signal lines 22. Various functions used for controlling the internal combustion engine are implemented in control unit 25. In modern control units, these functions are programmed on a computer and subsequently stored in a memory of control unit 25. The functions stored in the memory are activated as a function of the demands on the internal combustion engine, particularly sharp demands thereby being placed on the real-time capability of control unit 25. In principle, a pure hardware implementation of the control of the internal combustion engine is possible as an alternative to a software implementation.

Situated in induction tract 36 is a throttle valve 38 whose rotational position is adjustable by control unit 25 via a signal line 39 and an associated electrical actuator (not shown here).

A further ignition device 40 may be situated at the combustion chamber. Here, it may be a further spark plug in addition to spark plug 24, or, e.g., a laser or the like. The externally supplied ignition, described in the following, for bringing about the autoignition is triggered by further ignition device 40 or spark plug 24. Further ignition device 40 is controlled by control unit 25, and is electrically connected to it for that purpose.

In a first operating mode, the homogeneous operating mode of the internal combustion engine, throttle valve 38 is partially opened or closed as a function of the desired air mass to be supplied. During an induction stroke brought about by piston 29, the fuel is injected into combustion chamber 26 by fuel injector 18. Due to the air drawn in at the same time, the injected fuel is swirled and therefore distributed essentially uniformly/homogeneously in combustion chamber 26. Thereafter, during the compression stroke in which the volume of combustion chamber 26 is reduced by piston 29, the fuel/air mixture is compressed to then, as a rule, be ignited by spark plug 24 shortly before piston 29 reaches the top dead center.

In a second operating mode, the stratified-charge operating mode of the internal combustion engine, throttle valve 38 is opened wide. The fuel is injected into combustion chamber 26 by fuel injector 18 during the compression stroke brought about by piston 29. Thereupon, as before, the fuel is ignited with the aid of spark plug 24, so that in the working phase now taking place, piston 29 is driven by the expansion of the ignited fuel. A further possible operating mode is the homogeneous lean operating mode in which, as in homogeneous operation, fuel is injected into combustion chamber 26 during the induction phase.

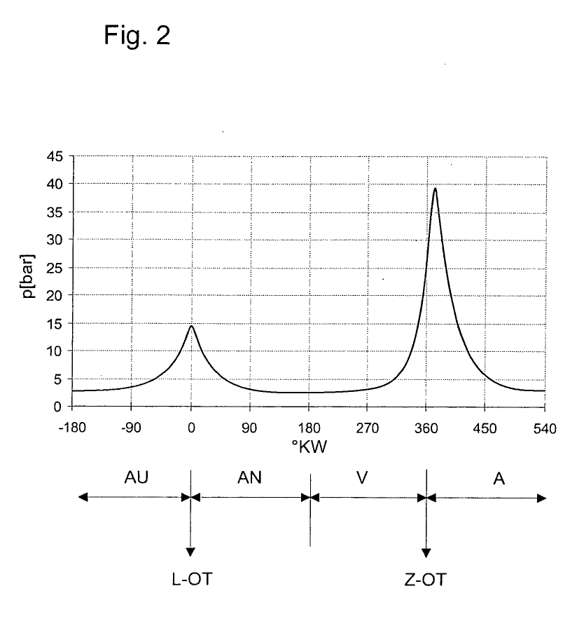

FIG. 2 shows a diagram of the combustion-chamber pressure in combustion chamber 26 of the internal combustion engine over the crankshaft angle in degrees crank angle (° KW). A crankshaft angle from −180° to 540° is shown over the ordinate, and the combustion-chamber pressure is plotted in bar over the abscissa. The top dead center in the charge cycle L-OT is arbitrarily selected here with 0°. The charge cycle is used in known manner for expelling combusted exhaust gases, which takes place here between −180° and 0° crank angle, and for drawing in fresh ambient air or a fuel/air mixture, which takes place here in the crankshaft angle range of 0-180°. One crankshaft rotation further, at 360° crank angle, the top dead center of the ignition Z-OT (ignition-OT) is reached. The compression stroke takes place between 180° crank angle in FIG. 2 and 360° crankshaft angle; the expansion of the combusting gases takes place between 360° crankshaft angle and 540° crankshaft angle. The individual strokes are denoted in FIG. 2 by expel AU from −180° to 0°, induction AN from 0° to 180°, compression stroke V from 180° to 360°, and expansion (combustion) A from 360° to 540°. In the compression stroke, the air, i.e., fuel/air mixture or fuel/air/exhaust-gas mixture is compressed and at the same time heated. As a rule, the mixture is ignited shortly before reaching the ignition OT. This may be accomplished as usual in the gasoline engine by externally supplied ignition or, according to the operating mode of the present invention, by a controlled autoignition. The ignition of the mixture leads, in known manner, to a pressure increase, which in the power stroke following it, is converted into mechanical energy.

In the operating mode of controlled autoignition, the injection in the stratified-charge operating mode takes place in the compression stroke, and the autoignition (see FIG. 2) takes place shortly before reaching the ignition OT (Z-OT). To that end, it is necessary that the gas/air/fuel/exhaust-gas mixture exhibit a sufficient ignition temperature.

The implementation of a cylinder shutoff is very sensitive in the case of the controlled autoignition of a gasoline engine, since the thermodynamic conditions necessary for the autoignition must be adjusted very precisely. The aid of a regulation (closed-loop control), which corrects a precontrol, is possibly necessary here.

First of all, switchover strategies from normal 4-stroke operation to the cylinder-shutoff mode are described with reference to Tables 1 to 4. In the transition from operation with externally supplied ignition to autoignition operating mode, it must be taken into consideration that a higher exhaust-gas temperature is generated during operation with externally supplied ignition. In the switchover, this should be considered during a brief transition phase (e.g., between 5 and 10 working cycles). This means that, at first, less residual gas is held back or returned in order to set the desired temperature for the autoignition. In the transition from operation with externally supplied ignition to autoignition operating mode, at first ignition always continues to take place in the same cylinder, and in the cylinders which are not ignited, ignition continues not to take place. Table 1 shows the possible switchover strategies when switching from operation with externally supplied ignition to autoignition operating mode.

TABLE 1

| | | |
|---|---|---|
| | Combustion process | |
| Cycle | Cylinder 1 | Cylinder shutoff |

Variant a)

| | | |
|---|---|---|
| . . . | Externally supplied ignition | No |
| Z (cycle) | Externally supplied ignition | No |
| Z + I | Autoignition | No (transition) |
| . . . | Autoignition | No (transition) |
| Z + x | Autoignition | No (end of transition) |
| . . . | Autoignition | No |

Variant b)

| | | |
|---|---|---|
| . . . | Externally supplied ignition | Yes |
| Z | Externally supplied ignition | Yes |
| Z + I | Autoignition | Yes (transition) |
| . . . | Autoignition | Yes (transition) |
| Z + x | Autoignition | Yes (end of transition) |
| . . . | Autoignition | Yes |

x = 5-10 cycles

The points . . . in each case stand for one or more working cycles. There are likewise two possibilities for the switchover from ignited operation to the cylinder shutoff. First of all, from the operation with externally supplied ignition to the cylinder shutoff, and secondly from the autoignition operating mode to the autoignition operating mode in (within) the cylinder-shutoff mode. In this context, because of the different exhaust-gas temperatures during operation with externally supplied ignition and autoignition operation, a transition phase must again be taken into account from the operation with externally supplied ignition. During the transition in autoignition operating mode to the cylinder shutoff, it must be taken into consideration that, because of the sudden load change in the cylinder continuing to be ignited, different exhaust-gas temperatures will easily appear. Table 2 shows the possible switchover strategies when switching from normal operation to cylinder shutoff.

TABLE 2

| | | |
|---|---|---|
| | Combustion process | |
| Cycle | Cylinder 1 | Cylinder shutoff |

Variant a)

| | | |
|---|---|---|
| . . . | Externally supplied ignition | No |
| Z | Externally supplied ignition | No |
| Z + I | Autoignition | Yes (transition) |
| . . . | Autoignition | Yes (transition) |
| Z + x | Autoignition | Yes (end of transition) |
| . . . | Autoignition | Yes |

x = 5-10 cycles

Variant b)

| | | |
|---|---|---|
| . . . | Autoignition | No |
| Z | Autoignition | No |
| Z + 1 | Autoignition | Yes (transition) |
| . . . | Autoignition | Yes (transition) |
| Z + x | Autoignition | Yes (end of transition) |
| . . . | Autoignition | Yes |

x = 3-6 cycles

The switchover from the cylinder shutoff back to normal operation can ensue due to: Load demand higher than attainable with cylinder shutoff or because of unstable autoignition operation (marginal area of the possible autoignition map or highly non-steady operation). In this case, it is possible from the cylinder shutoff to the normal operation, to then continue to drive in autoignition operating mode or operation with externally supplied ignition. Table 3 shows the possible switchover strategies when switching from cylinder shutoff to normal operation.

TABLE 3
Variant a)

| | Combustion process | |
|---|---|---|
| Cycle | Cylinder 1 | Cylinder shutoff |
| . . . | Autoignition | Yes |
| Z | Autoignition | Yes |
| Z + I | Externally supplied ignition | No (transition) |
| . . . | Externally supplied ignition | No (transition) |
| Z + x | Externally supplied ignition | No (end of transition) |
| . . . | Externally supplied ignition | No |

x = 3-6 cycles

In this case, the transition to operation with externally supplied ignition is only necessary because of the influence of the different exhaust-gas enthalpies or temperatures on the exhaust-gas emissions during operation with externally supplied ignition.

TABLE 3
Variant b)

| | Combustion process | |
|---|---|---|
| Cycle | Cylinder 1 | Cylinder shutoff |
| . . . | Autoignition | Yes |
| . . . | Autoignition | Yes |
| Z + I | Autoignition | No (transition) |
| . . . | Autoignition | No (transition) |
| Z + x | Autoignition | No (end of transition) |
| . . . | Autoignition | No |

x = 3-6 cycles

During the transition in autoignition operating mode out of the cylinder shutoff, it must be taken into consideration that, because of the sudden load change in the cylinder further ignited, different exhaust-gas temperatures will easily appear. The cylinder shutoff can be carried out in any cylinder as desired. In an n-cylinder engine, up to n−1 cylinders can be shut off. However, it is useful if half the cylinders are shut off, thus n/2, so that the smooth running is not too strongly impaired. In so doing, the cylinders are shut off alternately.

In particular, the autoignition is very sensitive to the charge temperature and composition (fresh air, fuel, residual gas—internal and/or external). Precisely in the case of small loads, a highest-possible charge temperature injection and valve timing strategies is necessary for operating an autoignition gasoline engine in order to still permit the autoignition. To achieve this, an internal exhaust-gas retention is preferred because of the slight heat loss possibly of the external exhaust-gas recirculation. Therefore, in a cylinder shutoff, the same cylinders must always be ignited, see Table 4 (e.g., in a 4-cylinder engine, always the same 2, or in a 6-cylinder engine, always the same 3, or in an 8-cylinder engine, always the same 4, etc.), and not simply a change made to a cylinder which just had no ignition (supposed to do no work), since no exhaust-gas enthalpy, which is indispensable for the autoignition, would exist here.

TABLE 4
(engine having n cylinders):

| | Combustion process | Combustion process |
|---|---|---|
| Cycle | Cylinder 1 | Cylinder 2 |
| . . . | Autoignition | No ignition |
| Z | Autoignition | No ignition |
| Z + 1 | Autoignition | No ignition |
| . . . | Autoignition | No ignition |

A further possibility for making the cylinder shutoff more flexible is, in a change from a cylinder, e.g., cycle Z, just (auto-) ignited, for instance, cylinder 1, to a cylinder not just ignited, for instance, cylinder 2, to first here in cycle Z+1 implement one or more power strokes with externally supplied ignition to thereby ensure the exhaust-gas enthalpy. In so doing, it is necessary to take care that no sudden changes are caused in the torque development. This can be realized by a reduction of the load in both cylinders between which the change takes place. The change is first carried out in cycle Z+2. Table 5 shows the transition from overrun fuel cutoff (no ignition) to autoignition and vice versa when working with two cylinders. To set the exhaust-gas temperatures necessary for the autoignition, one or more power strokes using an operating mode with externally supplied ignition are interposed, see Table 5.

TABLE 5
(engine having n cylinders):

| | Combustion process | Combustion process |
|---|---|---|
| Cycle | cylinder 1 | cylinder 2 |
| . . . | Autoignition | No ignition |
| Z | Autoignition | No ignition |
| Z + I | Autoignition | Externally supplied ignition (transition) |
| . . . | No ignition | Autoignition (transition) |
| Z + x | No ignition | Autoignition (end of transition) |
| . . . | No ignition | Autoignition |

x = 5-10 cycles

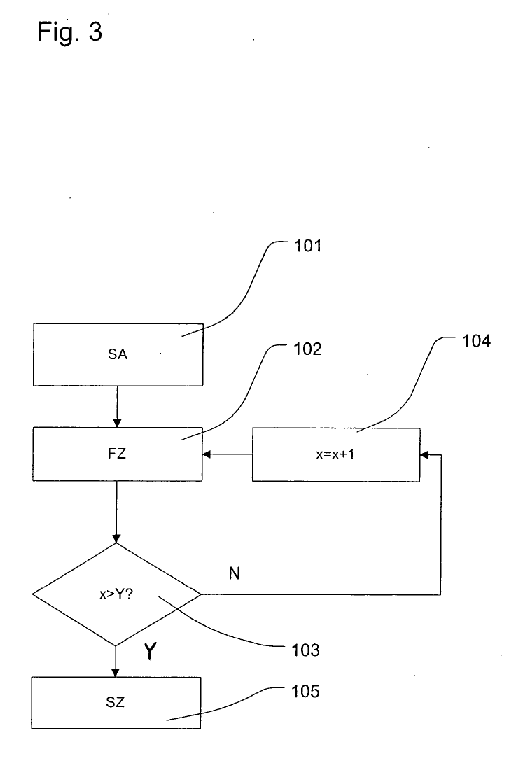

FIG. 3 shows a flowchart of the method according to the present invention using a transition from the overrun fuel cutoff operating mode SA to the controlled autoignition operating mode SZ as an example. Starting from overrun fuel cutoff SA in step 101, there is first a change to an operating mode with externally supplied ignition FZ in step 102. In this context, it may be a homogeneous or a stratified operating mode, or a homogeneous mixed operation. This operating mode is maintained over a plurality of power strokes, e.g., 10 power strokes. To that end, it is checked in step 103 whether the number of power strokes x is greater than a predefined number Y of power strokes; here, for example, the number Y=10 may be selected. If this is not the case—this is the option “N” like no in step 103—then in step 104, an internal counter is incremented by 1, and there is a branching back again to a power stroke with externally supplied ignition according to step 102. As soon as the number x=10 power strokes is reached, and the check in step 103 reads the result (Y) like yes, there is a branching to the operating mode of controlled autoignition SZ in step 105. On the other hand, the transition from controlled autoignition SZ to overrun fuel cutoff SA takes place directly, and is therefore not explained on the basis of a diagram. In this case, the injected fuel quantity is simply reduced to 0 for the transition to overrun fuel cutoff SA. This can be done within one power stroke, so that the corresponding cylinder changes to the overrun fuel cutoff operating mode.

What is claimed is:

1. A method for operating an internal combustion engine having a plurality of cylinders, the method comprising:
operating one part of the cylinders in an overrun fuel cutoff operating mode and another part of the cylinders in an autoignition operating mode.

2. The method according to claim 1, wherein the engine is a gasoline engine with direct gasoline injection.

3. The method according to claim 1, wherein a transition from the overrun fuel cutoff operating mode to the autoignition operating mode takes place via an operating mode with externally supplied ignition.

4. The method according to claim 1, wherein in a transition from the overrun fuel cutoff operating mode to the autoignition operating mode, a plurality of power strokes take place in an operating mode with externally supplied ignition.

5. The method according to claim 3, wherein between one and ten power strokes take place in the operating mode with externally supplied ignition.

6. The method according to claim 1, wherein a transition from the autoignition operating mode to the overrun fuel cutoff operating mode takes place directly.

7. The method according to claim 3, wherein the operating mode with externally supplied ignition is an operating mode with homogeneous mixture formation.

8. A control unit for an internal combustion engine having a plurality of cylinders, comprising:
means for operating one part of the cylinders in an overrun fuel cutoff operating mode and another part of the cylinders in an autoignition operating mode.

9. The control unit according to claim 8, wherein the engine is a gasoline engine with direct gasoline injection.
